(19) United States
(12) Patent Application Publication
(10) Pub. No.: US 2026/0103980 A1
(43) Pub. Date: Apr. 16, 2026

(54) RETAINER FOR A ROTATING BIT

(71) Applicant: The Sollami Company, Herrin, IL (US)

(72) Inventor: Phillip Sollami, Herrin, IL (US)

(73) Assignee: The Sollami Company, Herrin, IL (US)

(21) Appl. No.: 19/323,870

(22) Filed: Sep. 9, 2025

Related U.S. Application Data
(60) Provisional application No. 63/692,764, filed on Sep. 10, 2024.

(51) Int. Cl. E21C 35/197; B28D 1/18; E02F 9/28

(52) U.S. Cl. CPC E21C 35/197; B28D 1/186; E02F 9/2816

(57) ABSTRACT

A retainer for a rotating bit and/or pick that includes a tapered body portion and a slot extending from a forward end to a distal end of the retainer. The slot includes a gap profile formed by the configuration or design of a first radial end surface of the slot and a second radial end surface of the slot. The retainer includes a reduced diameter distal section adjacent the distal end of the retainer, the reduced diameter distal section including a forward portion and a distal portion each including an outer diameter that is less than an outer diameter of a sidewall of the retainer adjacent the reduced diameter distal section. The forward portion of the reduced diameter distal section is tapered axially inwardly in the distal direction and the distal portion of the reduced diameter distal section may be cylindrical or tapered axially inwardly in the distal direction as described in the exemplary illustrated embodiments.

### CROSS-REFERENCE TO RELATED APPLICATION(S)

This application claims priority to U.S. Provisional Application No. 63/692,764, filed Sep. 10, 2025, claims priority to and is a continuation-in-part of U.S. Non-provisional application Ser. No. 19/193,861, filed Apr. 29, 2025, claims priority to and is continuation-in-part of U.S. Provisional Application No. 63/640,040, filed Apr. 29, 2024, claims priority to and is a continuation-in-part of U.S. Provisional Application No. 63/750,354, filed Jan. 28, 2025, claims priority to and is a continuation-in-part of U.S. Provisional Application No. 63/692,764, filed Sep. 10, 2024, claims priority to and is a continuation-in-part of U.S. Provisional Application No. 63/676,221, filed Jul. 26, 2024, claims priority to and is a continuation-in-part of U.S. Non-provisional application Ser. No. 18/931,855, filed Oct. 30, 2024, claims priority to and is a continuation-in-part of U.S. Non-provisional application Ser. No. 18/437,987, filed Feb. 9, 2024, claims priority to and is a continuation-in-part of U.S. Provisional Application No. 63/621,178, filed Jan. 16, 2024, claims priority to and is a continuation-in-part of U.S. Non-provisional application Ser. No. 17/970,325, filed Oct. 20, 2022, claims priority to and is a continuation-in-part of U.S. Non-provisional application Ser. No. 18/059,662, filed Nov. 29, 2022, claims priority to and is a continuation-in-part of U.S. Non-provisional application Ser. No. 18/102,311, filed Jan. 27, 2023, claims priority to and is a continuation-in-part of U.S. Non-provisional application Ser. No. 18/134,659, filed Apr. 14, 2023, claims priority to and is a continuation-in-part of U.S. Provisional Application No. 63/466,041, filed May 12, 2023, claims priority to and is a continuation-in-part of U.S. Non-provisional application Ser. No. 18/236,672, filed Aug. 22, 2023, claims priority to and is a continuation-in-part of U.S. Provisional Application No. 63/547,036, filed Nov. 2, 2023, to the extent allowed by law and the contents of which are incorporated herein by reference in their entireties. The contents of Applicant's co-pending U.S. Non-Provisional application Ser. No. 17/877,084, filed Jul. 29, 2022, Applicant's co-pending U.S. Non-Provisional application Ser. No. 17/146,992, filed Jan. 12, 2021, Applicant's U.S. Provisional Application No. 62/898,654, filed Sep. 11, 2019, Applicant's U.S. Provisional Application No. 62/965,237, filed Jan. 24, 2020, Applicant's U.S. Pat. No. 10,107,098, issued Oct. 23, 2018, and Applicant's U.S. Pat. No. 10,612,376, issued Apr. 7, 2020, are incorporated herein by reference in their entireties. The contents of Applicant's co-pending U.S. Non-provisional application Ser. No. 17/970,325, filed Oct. 20, 2022; Applicant's co-pending U.S. Non-provisional application Ser. No. 18/059,662, filed Nov. 29, 2022; Applicant's co-pending U.S. Non-provisional application Ser. No. 18/102,311, filed Jan. 27, 2023; Applicant's co-pending U.S. Non-provisional application Ser. No. 18/134,659, filed Apr. 14, 2023; Applicant's expired U.S. Provisional Application No. 63/466,041, filed May 12, 2023; Applicant's co-pending U.S. Non-provisional application Ser. No. 18/236,672, filed Aug. 22, 2023; Applicant's co-pending U.S. Provisional Application No. 63/547,036, filed Nov. 2, 2023; Applicant's co-pending U.S. Provisional Application No. 63/621,178, filed Jan. 16, 2024; Applicant's co-pending U.S. Non-provisional application Ser. No. 18/437,987, filed Feb. 9, 2024; Applicant's co-pending U.S. Provisional Application No. 63/634,745, filed Apr. 16, 2024; Applicant's co-pending U.S. Provisional Application No. 63/640,040, filed Apr. 29, 2024; Applicant's co-pending U.S. Provisional Application No. 63/676,221, filed Jul. 26, 2024; Applicant's co-pending U.S. Non-Provisional application Ser. No. 17/877,084, filed Jul. 29, 2022; Applicant's U.S. Non-Provisional application Ser. No. 17/146,992, filed Jan. 12, 2021, now U.S. Pat. No. 11,891,825, issued Feb. 6, 2024; Applicant's U.S. Provisional Application No. 62/898,654, filed Sep. 11, 2019; Applicant's U.S. Provisional Application No. 62/965,237, filed Jan. 24, 2020; Applicant's U.S. Pat. No. 10,107,098, issued Oct. 23, 2018; and Applicant's U.S. Pat. No. 10,612,376, issued Apr. 7, 2020, are incorporated herein by reference in their entireties.

### TECHNICAL FIELD

This disclosure relates to a bit and/or pick for road milling, mining, and trenching equipment, and more particularly, to a retainer for a rotating bit and/or non-rotating bit.

### BACKGROUND

Road milling, mining, and trenching equipment utilizes bits and/or picks traditionally set in a bit assembly. Bit assemblies can include a bit and/or pick retained within a bore in a base block. Bit assemblies can also include a bit and/or pick retained by a bit holder and the bit holder retained within a bore in a base block. A plurality of the bit assemblies are mounted on the outside of a rotatable drum, typically in a V-shaped or spiral configuration. A plurality of the bit assemblies can also be mounted on an endless chain and plate configurations. The combinations of bit assemblies have been utilized to remove material from the terra firma, such as degrading the surface of the earth, minerals, cement, concrete, macadam or asphalt pavement. Individual bits and/or picks, bit holders, and base blocks may wear down or break over time due to the harsh road degrading environment. Additionally, the forces and vibrations exerted on the bit assemblies may cause the bit and/or pick to wear away the bore in the base block, the bit and/or pick to wear away the bore in the bit holder, or the bit holder to wear away the bore in the base block. For rotating bits, a slotted retainer, sleeve, and washer disposed circumferentially around the bit shank, for example, are used to maintain the bit in the bit holder. The separate washer will generally attach itself to the rear annular flange of the bit body in a non-parallel or askew fit while in use, which prevents the bit body from freely rotating thereby substantially reducing the bit life. Over time, a gap forms between a bottom of the bit body and a forward face of the bit holder, allowing dirt, debris, and fines to enter the space between the outer diameter of the bit shank and the inner diameter of the retainer, resulting in poorer rotation of the bit, reducing the life of a carbide tip of the bit and increasing the bit holder face wear, such as an flat annular face at a forward end of the bit holder, and bit holder bore wear, thereby requiring replacement of the bit, bit holder, and/or base block long before the standard minimum lifetime required by the industry.

To prolong the life of the bit assembly, and the bit holder and/or the base block, a bit and/or pick comprising a slotted retainer with varying features adjacent a distal end of the retainer will not only ease the insertion of the bit into the bit holder, reduce costs, and reduce axial movement. The slotted retainer of the present disclosure also forms nearly 100 percent sealed areas between the inner diameter of the retainer and the outer diameter or the shank, between the bottom of the bit body planar surface adjacent the tire and bit shank and the retainer, and between the retainer and the bore of the bit holder, thereby providing nearly 100 percent uninhibited rotation of the bit, increasing the life of the bit tip insert of the bit due to improved rotation, and increasing the overall life span of the bit, bit holder, and base block.

### SUMMARY

This disclosure relates generally to bit and/or pick assemblies for road milling, mining, and trenching equipment. One implementation of the teachings herein is a retainer that includes a tapered body portion including an axial forward end and an axial distal end; a first slot extending through a sidewall of the tapered body portion from the axial forward end to adjacent the axial distal end; and a reduced diameter distal section adjacent the axial distal end of the retainer, the reduced diameter distal section including a forward portion and a distal portion each comprising an outer diameter that is less than an outer diameter of the tapered body portion of the retainer forward of the reduced diameter distal section.

In another implementation of the teachings herein is a bit that includes a unitary body portion including a washer portion adjacent a distal end of the unitary body portion, the washer portion integrally formed as part of the unitary body portion; a generally cylindrical shank depending from a bottom of the body portion; and a retainer disposed circumferentially about the shank, the retainer including: a tapered body portion including an axial forward end and an axial distal end; a first slot extending through a sidewall of the tapered body portion from the axial forward end to adjacent the axial distal end; and a reduced diameter distal section adjacent the axial distal end of the retainer, the reduced diameter distal section including a forward portion and a distal portion each comprising an outer diameter that is less than an outer diameter of the tapered body portion of the retainer forward of the reduced diameter distal section.

These and other aspects of the present disclosure are disclosed in the following detailed description of the embodiments, the appended claims and the accompanying figures.

### BRIEF DESCRIPTION OF THE DRAWINGS

The various features, advantages, and other uses of the apparatus will become more apparent by referring to the following detailed description and drawings, wherein like reference numerals refer to like parts throughout the several views. It is emphasized that, according to common practice, the various features of the drawings are not to-scale. On the contrary, the dimensions of the various features are arbitrarily expanded or reduced for clarity.

FIG. 1 is a top perspective view of a prior art retainer showing a reduced diameter distal section, a slot including a linear gap profile, a dual corner break at the distal end of the retainer, a relief notch, a compression slot, and a plurality of tabs;

FIG. 2 is a top elevation view of the prior art retainer showing the reduced diameter distal section, the slot, the dual corner break, the relief notch, and the compression slot;

FIG. 3 is a detail cross-sectional view of Detail A of the prior art retainer of FIG. 2;

FIG. 4 is a top perspective view of the prior art retainer showing the reduced diameter distal section, the slot, the dual corner break, the relief notch, and the plurality of tabs;

FIG. 5 is a left side elevation view of the prior art retainer showing the reduced diameter distal section and one tab;

FIG. 6 is a distal end elevation view of the prior art retainer showing the slot, the dual corner break, the relief notch, the compression slot, and the plurality of tabs;

FIG. 7 is a right side elevation view of the prior art retainer showing the reduced diameter distal section and one tab;

FIG. 8 is a bottom perspective view of the prior art retainer showing the reduced diameter distal section, the slot, the dual corner break, the relief notch, the compression slot, and the plurality of tabs;

FIG. 9 is a bottom elevation view of the prior art retainer showing the reduced diameter distal section, the relief notch, and the compression slot;

FIG. 10 is a bottom perspective view of the prior art retainer showing the reduced diameter distal section, the slot, the dual corner break, the relief notch, the compression slot, and the plurality of tabs;

FIG. 11 is a bottom elevation view of a first illustrated embodiment of a retainer, showing a reduced diameter distal section adjacent a distal end of the retainer, a dual corner break at the distal end of the retainer, a relief notch extending from the distal end of the retainer, and a compression slot extending from a distal end of the relief notch, in accordance with implementations of this disclosure;

FIG. 12 is a side elevation view of the first illustrated embodiment of the retainer, showing the reduced diameter distal section adjacent the distal end of the retainer, the dual corner break, and one tab of a plurality of tabs adjacent the distal end of the retainer, showing invisible internal elements in dotted lines, in accordance with implementations of this disclosure;

FIG. 13 is a cross-sectional view of the first illustrated embodiment of the retainer taken along Line B-B of FIG. 12 in accordance with implementations of this disclosure;

FIG. 14 is a detail cross-sectional view of Detail C of the first illustrated embodiment of the retainer of FIG. 13 in accordance with implementations of this disclosure;

FIG. 15 is a top elevation view of the first illustrated embodiment of the retainer, showing the reduced diameter distal section, a slot including a linear gap profile, the relief notch, and the compression slot, in accordance with implementations of this disclosure;

FIG. 16 is a top-side elevation view of the first illustrated embodiment of the retainer, showing the reduced diameter distal section, the slot, the relief notch, and the plurality of tabs, in accordance with implementations of this disclosure;

FIG. 17 is a bottom-side elevation view of the first illustrated embodiment of the retainer, showing the reduced diameter distal section, the relief notch, the compression slot, and the plurality of tabs, in accordance with implementations of this disclosure;

FIG. 18 is a distal end elevation view of the first illustrated embodiment of the retainer, showing the reduced diameter distal section, the relief notch, the compression slot, and the plurality of tabs, in accordance with implementations of this disclosure;

FIG. 19 is a top perspective view of the first illustrated embodiment of the retainer, showing the reduced diameter distal section, the slot, the dual corner break, the relief notch, and the plurality of tabs, in accordance with implementations of this disclosure;

FIG. 20 is a top elevation view of the first illustrated embodiment of the retainer, showing the reduced diameter distal section, the slot, the dual corner break, the relief notch, and the compression slot, in accordance with implementations of this disclosure;

FIG. 21 is a detail cross-sectional view of Detail D of the first illustrated embodiment of the retainer of FIG. 20 in accordance with implementations of this disclosure;

FIG. 22 is a top perspective view of the first illustrated embodiment of the retainer, showing the reduced diameter distal section, the slot, the dual corner break, the relief notch, and the plurality of tabs, in accordance with implementations of this disclosure;

FIG. 23 is a left side elevation view of the first illustrated embodiment of the retainer, showing the reduced diameter distal section and one tab, in accordance with implementations of this disclosure;

FIG. 24 is a distal end elevation view of the first illustrated embodiment of the retainer, showing the slot, the dual corner break, the relief notch, the compression slot, and the plurality of tabs, in accordance with implementations of this disclosure;

FIG. 25 is a right side elevation view of the first illustrated embodiment of the retainer, showing the reduced diameter distal section and one tab, in accordance with implementations of this disclosure;

FIG. 26 is a bottom perspective view of the first illustrated embodiment of the retainer, showing the reduced diameter distal section, the slot, the dual corner break, the relief notch, the compression slot, and the plurality of tabs, in accordance with implementations of this disclosure;

FIG. 27 is a bottom elevation view of the first illustrated embodiment of the retainer, showing the reduced diameter distal section, the relief notch, and the compression slot, in accordance with implementations of this disclosure;

FIG. 28 is a bottom perspective view of the first illustrated embodiment of the retainer, showing the reduced diameter distal section, the slot, the dual corner break, the relief notch, the compression slot, and the plurality of tabs, in accordance with implementations of this disclosure;

FIG. 29 is an exploded side elevation view of a first illustrated embodiment of a bit assembly, showing a base block, a bit holder, the first illustrated embodiment of the retainer, and a first illustrated embodiment of a bit, showing invisible internal elements in dotted lines, in accordance with implementations of this disclosure;

FIG. 30 is an exploded side elevation view of the first illustrated embodiment of the bit assembly, shown with the bit holder assembled into a bore of the base block and with the first illustrated embodiment of the retainer assembled circumferentially around a shank of the first illustrated embodiment of the bit, in accordance with implementations of this disclosure;

FIG. 31 is a side elevation view of the first illustrated embodiment of the bit assembly, shown after initial insertion of the shank of the bit into a bore of the bit holder, in accordance with implementations of this disclosure;

FIG. 32 is a detail cross-sectional view of Detail E of FIG. 31 in accordance with implementations of this disclosure;

FIG. 33 is a detail cross-sectional view of Detail F of FIG. 32 in accordance with implementations of this disclosure;

FIG. 34 is a side elevation view of the first illustrated embodiment of the bit assembly, shown with the shank of the bit inserted approximately halfway into the bore of the bit holder, in accordance with implementations of this disclosure;

FIG. 35 is a detail cross-sectional view of Detail G of FIG. 34 in accordance with implementations of this disclosure;

FIG. 36 is a distal end elevation view of the first illustrated embodiment of the bit assembly, shown with the first illustrated embodiment of the retainer assembled circumferentially around the shank of the first illustrated embodiment of the bit, the shank of the bit fully inserted into the bore of the bit holder, and the bit holder assembled into the bore of the base block, in accordance with implementations of this disclosure;

FIG. 37 is a cross-sectional view of the first illustrated embodiment of the bit assembly taken along Line H-H of FIG. 36, in accordance with implementations of this disclosure;

FIG. 38 is a detail cross-sectional view of Detail I of FIG. 37 in accordance with implementations of this disclosure;

FIG. 39 is a top elevation view of a bit assembly, shown with the first illustrated embodiment of the retainer assembled circumferentially around the shank of the first illustrated embodiment of the bit and the shank of the bit assembled into a bore of a prior art base block, in accordance with implementations of this disclosure;

FIG. 40 is a cross-sectional view of the bit assembly taken along Line J-J of FIG. 39 in accordance with implementations of this disclosure;

FIG. 41 is a detail cross-sectional view of Detail K of FIG. 40 in accordance with implementations of this disclosure;

FIG. 42 is a bottom perspective view of the first illustrated embodiment of the retainer, showing the wear pattern, in accordance with implementations of this disclosure;

FIG. 43 is a distal end perspective view of the first illustrated embodiment of the retainer, showing the wear pattern, in accordance with implementations of this disclosure; and

FIG. 44 is a top perspective view of the first illustrated embodiment of the retainer, showing the wear pattern, in accordance with implementations of this disclosure.

### DETAILED DESCRIPTION

Road milling, mining, and trenching equipment utilizes bits and/or picks traditionally set in a bit assembly. Bit assemblies can include a bit and/or pick retained within a bore in a base block. For rotating bits, a slotted retainer, sleeve, and washer disposed circumferentially around the bit shank, for example, have typically been used to maintain a milling bit in the bit holder. The washer is disposed circumferentially about the bit shank/retainer and partially or entirely behind a rear annular flange of the bit body, attempting to avoid any cocking which would prevent the bit from rotating properly. Generally, a drum comprising the milling bits rotates at approximately 90 rpm, which causes the milling bits on the drum to rotate incrementally. Some washers are designed with a counterbore feature that allows a bottom flat surface of the counterbore to be positioned behind the rear annular flange of the bit body and an inner diameter of the counterbore to be positioned over and around a tire diameter of a tire portion of the bit body.

The separate washer will generally attach itself to the rear annular flange of the bit body in a non-parallel or askew fit while in use, which prevents the bit body from freely rotating thereby substantially reducing the bit life. Over time, a gap forms between a bottom of the bit body and a forward face of the bit holder and the washer will begin interfering with bit rotation, developing more clearance between the inner diameter of the retainer and the outer diameter of the bit shank, thereby allowing dirt, debris, and fines to enter the space between the outer diameter of the bit shank and the inner diameter of the retainer, resulting in poorer rotation of the bit, reducing the life of a carbide tip of the bit and increasing the bit holder bore wear, thereby requiring replacement of the bit, bit holder, and/or base block long before the standard minimum lifetime required by the industry.

The separate washer of the prior art bit design generally inhibits rotation due to the multiple interacting components of the bit body, the independent washer, and the retainer. To prolong the life of the bit assembly, and the bit holder and/or the base block, a bit and/or pick comprising a bit body including an integral washer feature and a bit shank including a slotted retainer with varying features adjacent a distal end of the retainer will not only ease the insertion of the bit into the bit holder, reduce costs, and reduce axial movement. The unibody design that incorporates the one-piece washer feature at a distal portion of the bit body significantly improves bit rotation. Superior bit rotation enhances the life of the carbide tip, which also increases the life of the cutter bit. The slotted retainer of the present disclosure also forms nearly 100 percent sealed areas between the inner diameter of the retainer and the outer diameter or the shank, between the bottom of the bit body and the forward end of the retainer, and between the retainer and the bore of the bit holder, thereby providing nearly 100 percent uninhibited rotation of the bit, increasing the life of the bit tip insert of the bit due to improved rotation, and increasing the overall life span of the bit, bit holder, and base block.

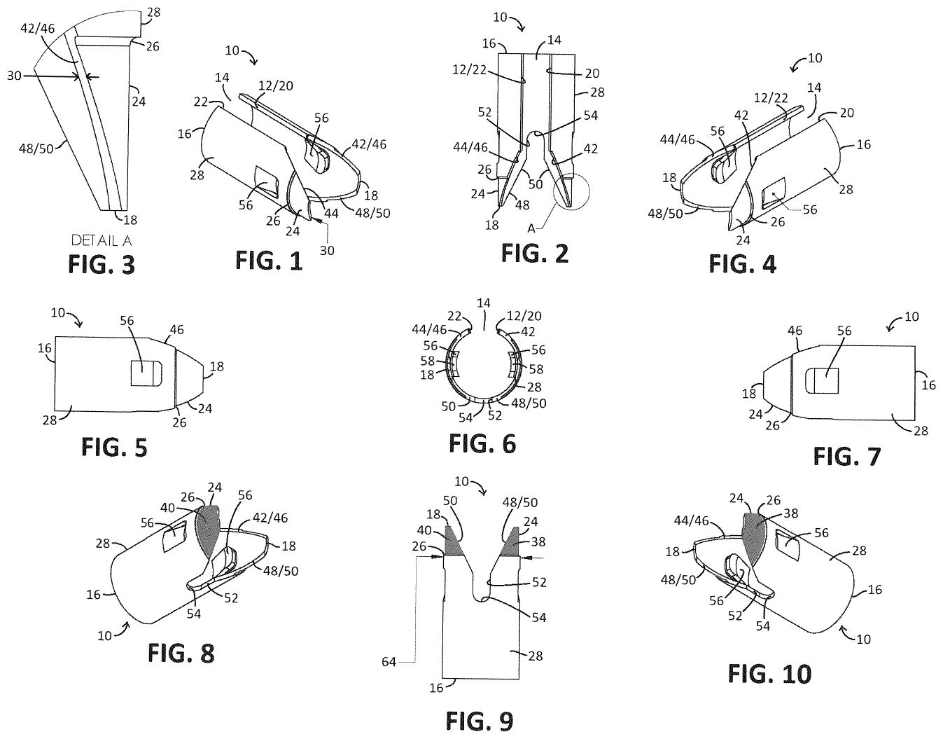

Referring to FIGS. 1-10, a prior art retainer 10 includes a slot 12 axially extending from a forward end 16 of the retainer 10 to a distal end 18 of the retainer 10. The slot 12 comprises a gap profile 14 that is defined by a first radial end surface 20 of the slot 12 and a second radial end surface 22 of the slot 12. In this exemplary illustrated implementation, the radial end surfaces 20, 22 are linear throughout their axial length thereby defining a linear gap profile 14. The retainer 10 further comprises a first angled portion 42 that extends from the distal end 18 of the retainer 10 to the first radial end surface 20 of the slot 12 and a second angled portion 44 that extends from the distal end 18 of the retainer 10 to the second radial end surface 22 of the slot 12. A dual corner break 46 (FIG. 2) is formed by the first angled portion 42 and the second angled portion 44.

The retainer 10 comprises a reduced diameter distal section 24 adjacent the distal end 18 of the retainer 10. The reduced diameter distal section 24 axially extends to an annular or stepped shoulder 26 disposed between the reduced diameter distal section 24 and an outer surface 28 of the retainer 10. The annular shoulder 26 increases, or steps up, as it axially extends from the reduced diameter distal section 24 to the outer surface 28 of the retainer 10, the reduced diameter distal section 24 of the retainer 10 thereby comprising a thickness 30 (FIG. 3) and an outer diameter 32 (not shown) that are less than a thickness 34 (not shown) and an outer diameter 36 (not shown) of the rest of the retainer 10, thereby allowing a small amount of radial interference between the reduced diameter distal section 24 of the retainer 10 and a bore of a bit holder upon initial manual insertion of a bit into the bore of the bit holder and allowing the initial manual insertion of the bit into the bore of the bit holder regardless of whether the bit holder is new or used. The thickness 30 of the reduced diameter distal section 24 of the prior art retainer 10 can be in the range of and including 0.002-0.045 inch on a retainer 10 including a thickness 34 of 0.050 inch. The reduced diameter distal section 24 allows about 50% less distal end 18 contact at a first contact surface 38 and a second contact surface 40 on the retainer 10 with the inner wall of the bore of the bit holder, which is beneficial during the initial insertion of the retainer 10 into the bore of the bit holder. The reduced outer diameter 32 (not shown) of the reduced diameter distal section 24 not only allows easier insertion of the bit into the bore of the bit holder, but also does not restrict the amount of axial insertion of the bit into a bit/retainer assembly until contact occurs.

The retainer 10 further comprises a relief notch or v-notch 48, which is angular in this exemplary illustrated implementation, extending from the distal end 18 of the retainer 10. The relief notch 48 comprises a pair of angular sides 50 (FIG. 9) that extend from the distal end 18 of the retainer 10 to a compression slot 52 (FIGS. 2 and 8-10). The compression slot 52 axially extends from a central portion of the relief notch 48 to a slot termination 54 adjacent the distal end 18 of the retainer 10. The relief notch 48 and compression slot 52 can axially extend from the distal end 18 of the retainer 10 and the relief notch 48, respectively, towards the forward end 16 of the retainer 10.

The retainer 10 comprises two axially and radially inwardly extending axial locator tabs 56 comprising a forward end that is a predetermined distance from the forward end 16 of the retainer 10. A distal end 58 of each tab 56 is disposed adjacent the distal end 18 of the retainer 10 and are approximately 180 degrees apart from one another. The distal ends 58 of the tabs 56 are disposed a predetermined distance from the forward end 16 of the retainer 10 and control the axial movement of the bit body during use. The two axial locator tabs 56 are each radially inwardly positioned on a portion of the retainer 10, each forming a tab aperture 60 (not shown) on the wall of the retainer 10 that terminates at a distal end 62 (not shown) of the tab aperture 60.

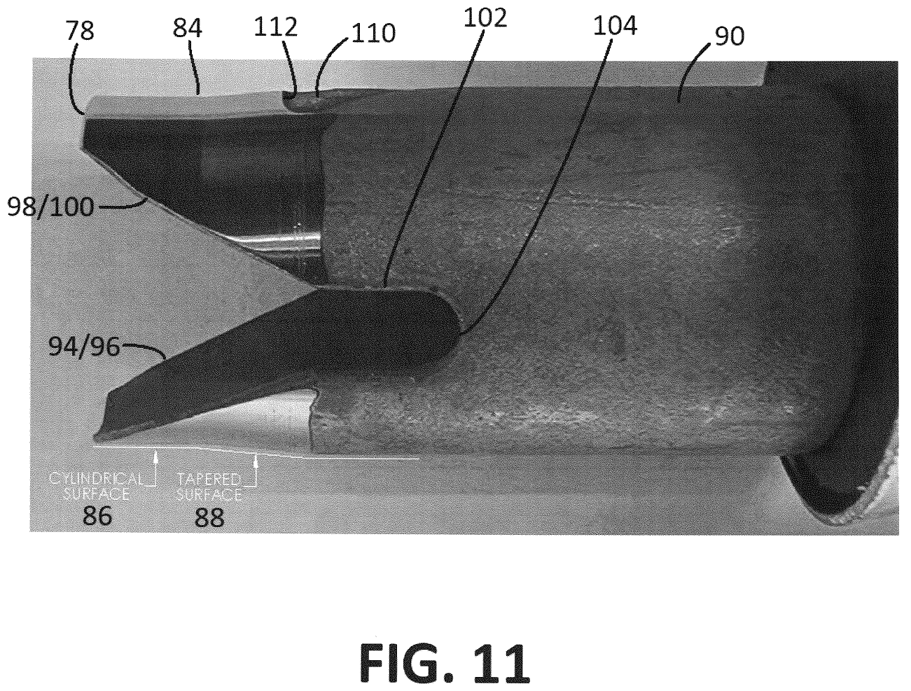

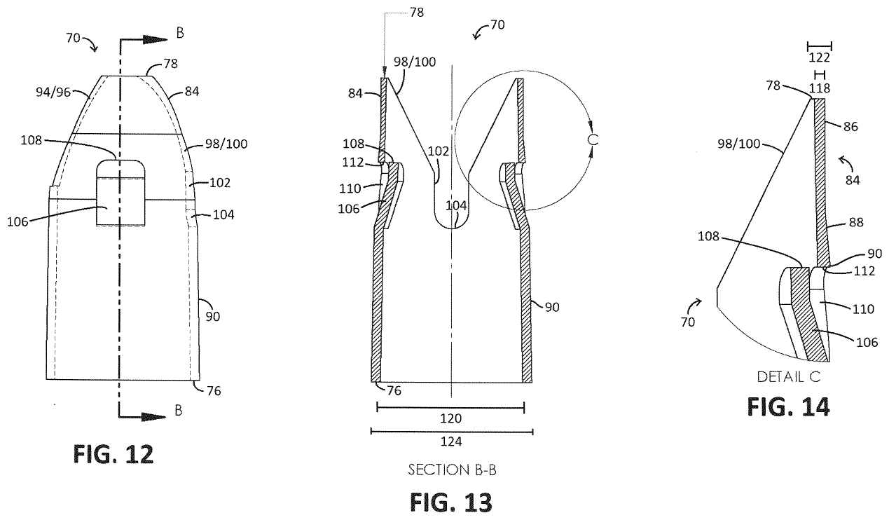

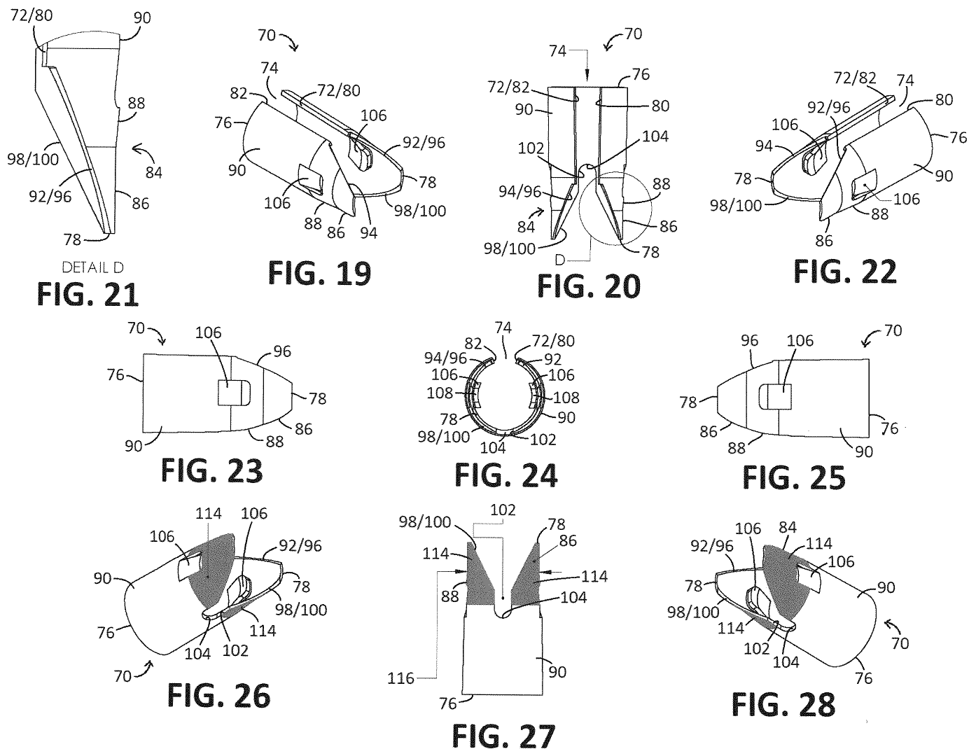

Referring to FIGS. 11-28, a first illustrated embodiment of a retainer 70 is shown in accordance with implementations of this disclosure. Retainer 70 includes a slot 72 axially extending from a forward end 76 of the retainer 70 to a distal end 78 of the retainer 70. The slot 72 comprises a gap profile 74 that is defined by a first radial end surface 80 of the slot 72 and a second radial end surface 82 of the slot 72. In this exemplary illustrated implementation, the radial end surfaces 80, 82 are linear throughout their axial length, thereby defining a linear gap profile 74. In alternate embodiments, the radial end surfaces 80, 82 and the gap profile 74 may be parallel, serpentine, arcuate, angular, zig-zagged, or any other configuration that can be formed by the radial end surfaces 80, 82 of the slot 72 or combination of same.

The retainer 70 comprises a reduced diameter distal section 84 adjacent the distal end 78 of the retainer 70. In this exemplary illustrated implementation, the reduced diameter distal section 84 is generally cylindrical and may comprise a generally cylindrical outer surface 86 adjacent the distal end 78 of the retainer 70 and a tapered outer surface 88 adjacent the generally cylindrical outer surface 86. In other embodiments (not shown), the reduced diameter distal section 84 may comprise a first tapered outer surface adjacent the distal end 78 of the retainer and a second tapered outer surface adjacent the first tapered outer surface forming a graduated radial curve, arc, and/or segment that slopes from the forward end of the of the generally cylindrical outer surface 86 of the reduced diameter distal section 54 to the distal end of the tapered outer surface 88 of the reduced diameter distal section 84 adjacent the generally cylindrical outer surface 86. The tapered outer surface 88 of the reduced diameter distal section 84 comprises an outward taper that axially extends to an outer surface 90 of the retainer 70 or an inward taper as it axially extends from the outer surface 90 of the retainer 70 towards the generally cylindrical outer surface 86 of the reduced diameter distal section 84, as shown in FIG. 11. The tapered outer surface 88 of the reduced diameter distal section 84 may comprise a shallow taper that eventually meets and/or terminates at the full diameter of a tapered region 126 (FIG. 17) of the outer surface 90 of the retainer 70 adjacent the reduced diameter distal section 84. Due to the tapered region 126 of the outer surface 90 of the retainer 70, as shown in FIGS. 17 and 20, the forward end 76 of the retainer 70 is larger than the concentric radial reduced diameter distal section 84 of the retainer 70, thereby allowing higher radial retention force to be applied at the forward end 76 of the retainer 70 and a gradual diminishing radial force applied towards the distal end 78 of the retainer 70.

In this exemplary illustrated implementation, the tapered outer surface 88 of the reduced diameter distal section 84 may comprise 5-50% of an axial length of the retainer 70. The tapered outer surface 90 of the retainer 70 is inwardly tapered towards the distal end 78 of the retainer 70 and may comprise, in this exemplary illustrated implementation, a taper in the range of and including nearly zero degrees to five degrees. In other implementations, the outer surface 90 of the retainer 70 may include tapers of varying degrees. Due to the tapered outer diameter profile of the retainer 70, the gap profile 74 defined by slot 72 is wider at the forward end 76 of the retainer 70.

The reduced diameter distal section 84 of the retainer 70 comprises a thickness 118 (FIG. 14) and an outer diameter 120 (FIG. 13) that are less than a thickness 122 (FIG. 14) and an outer diameter 124 (FIG. 13) of the rest of the retainer 70, thereby allowing a small amount of radial interference between the generally cylindrical outer surface 86 of the reduced diameter distal section 84 of the retainer 70 and a bore of a bit holder upon initial manual insertion of a bit into the bore of the bit holder and allowing the initial manual partial insertion of the bit into the bore of the bit holder regardless of whether the bit holder is new or used. The outer diameter 124 of the retainer 70 at the forward end 76 of the retainer 70 (Location “B” in FIG. 17) is larger than the outer diameter 124 of the retainer 70 adjacent the distal end 78 of the retainer 70 (Location “A” in FIG. 17). The thickness 118 of the reduced diameter distal section 84 of retainer 70 can be in the range of and including 0.002-0.045 inch on a retainer 70 including a thickness 122 of 0.050 inch. The reduced diameter distal section 84 allows about 50% less radial distal end 78 contact at a first contact surface 114 and a second contact surface 114 on the retainer 70 with the inner wall of the bore of the bit holder, which is beneficial during the initial insertion of the retainer 70 into the bore of the bit holder. The reduced outer diameter 120 of the reduced diameter distal section 84 not only allows easier insertion of the bit into the bore of the bit holder, but also sufficiently secures the bit into the bit holder bore prior to full insertion by hammer strokes.

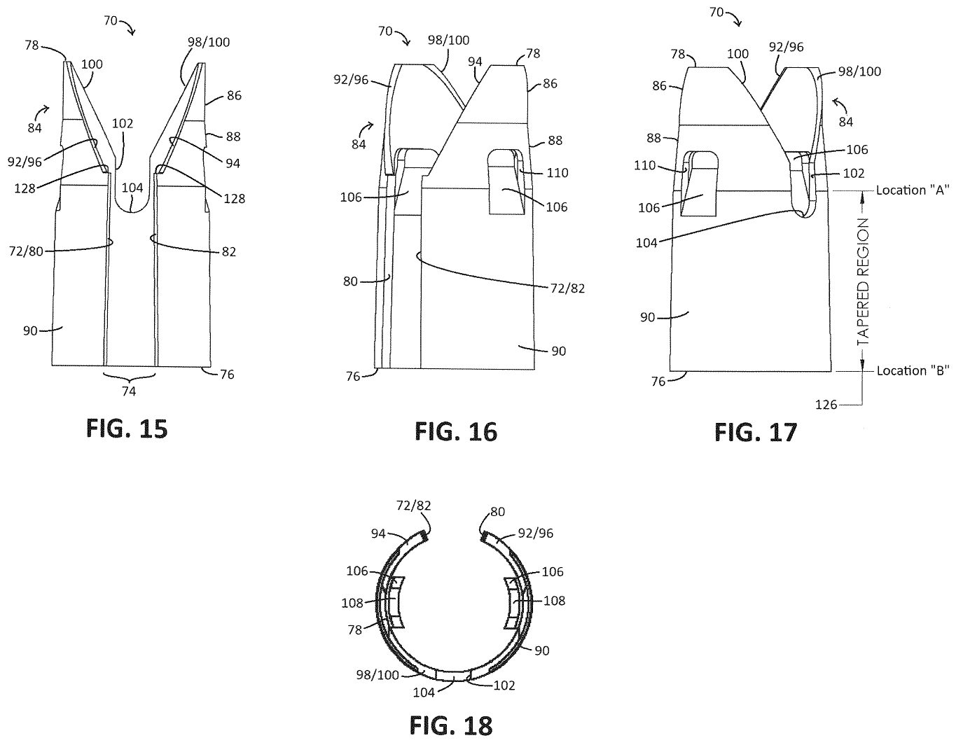

The retainer 70 further comprises a first angled portion 92 that extends from the distal end 78 of the retainer 70 to a dual locator notch 128 (FIG. 15) adjacent the first radial end surface 80 of the slot 72 and a second angled portion 94 that extends from the distal end 78 of the retainer 70 to the dual locator notch 128 (FIG. 15) adjacent the second radial end surface 82 of the slot 72. A dual corner break 96 (FIG. 15) is formed by the first angled portion 92 and the second angled portion 94 adjacent the distal end of the slot 72, each angled portion 92, 94 extending to the dual locator notches 128 on each side of the slot 72, which allows for good and/or easier insertion of the distal end 78 of the retainer 70, disposed circumferentially about a shank of a bit, into a bore of a bit holder such as those in Applicant's co-pending applications described and incorporated herein by reference in their entireties.

The retainer 70 comprises a relief notch or v-notch 98, which is angular in this exemplary illustrated implementation, extending from the distal end 78 of the retainer 70. The relief notch 98 comprises a pair of angular sides 100 that extend from the distal end 78 of the retainer 70 to a compression slot 102. The compression slot 102 axially extends from a central portion of the relief notch 98 to a slot termination 104 adjacent the distal end 78 of the retainer 70. The relief notch 98 and compression slot 102 can axially extend from the distal end 78 of the retainer 70 and the relief notch 98, respectively, towards the forward end 76 of the retainer 70. The axial length of the relief notch 98 and the axial length of the compression slot 102 are application specific and may be of variable length, allowing the slot termination 104 to be disposed anywhere along the axial length of the retainer 70. Due to the omission of a washer, an axially longer relief notch and/or compression slot are used to reduce the retainer compression strength at the distal end 78 of the retainer 70 and allow easier retainer insertion into the bore of the bit holder.

The retainer 70 further comprises at least one axially and radially inwardly extending axial locator tab 106 comprising a forward end that is a predetermined distance from the forward end 76 of the retainer 70. In this exemplary illustrated implementation, retainer 70 comprises two axial locator tabs 106 that axially extend to a distal end 108 of the tab 106 adjacent the distal end 78 of the retainer 70 and are approximately 180 degrees apart from one another. The distal ends 108 of the tabs 106 are disposed a predetermined distance from the forward end 76 of the retainer 70 and control the axial movement of the bit body during use. The two axial locator tabs 106 are each radially inwardly positioned on a portion of the retainer 70, each forming a tab aperture 110 on the wall of the retainer 70 that terminates at a distal end 112 of the tab aperture 110. The distal ends 108 of the tabs 106 are adapted to engage a recess or flange on the bit shank adjacent the distal end of the bit to prevent the retainer 70 from being removed from the bit shank when the bit is in use and when it is extracted from the bore of the bit holder. In other embodiments, the retainer may include any number of axially and radially inwardly extending tabs. In yet another embodiment, the retainer 70 can comprise at least one aperture (not shown) that is a predetermined distance from the forward end 76 of the retainer 70. In yet other embodiments, the retainer may simply comprise a generally cylindrical collapsible body portion and a slot that axially extends along the length of the retainer and creates a narrow gap between opposing sidewalls or radial end surfaces of the slot, the slot comprising a gap profile defined by the opposing sidewalls with various possible configurations and/or combinations as described above. These hollow retainers described herein with simply a slot along the axial length of the retainer from its forward end to its distal end are positioned on the shank of the bit between two vertical shoulders that are spaced axially to allow bit rotation while in use.

The retainer 70 is made of a material that allows the retainer 70 to act like a spring. The retainer 70 can be compressed to a certain degree and still bounce back to nearly its original configuration when the compression is released. A heat-treated retainer will allow more radial compressibility without taking a permanent set than a non-heat-treated retainer. The type of material used to make the retainer and the material's alloy constituents determine the impact value, strength, and radial compressibility of the retainer. In this exemplary illustrated implementation, retainer 70 is made from 6150 steel, a highly alloyed steel, providing the retainer 70 with a higher impact value and a higher strength, thereby allowing the retainer 70 to withstand a greater radial load without going beyond its yield limit and taking a permanent set, providing better overall performance over the life and use of the retainer as compared with the non-alloy materials used for prior art retainers, and extending the life of a bit holder in which it is used. In other embodiments, the retainer can be made with any other suitable material as well.

As with the embodiments of the retainers described herein, the reduced diameter distal section 84 allows less distal end 78 contact at the contact surfaces 114 (FIGS. 26-28) formed by the reduced diameter distal section 84 of the retainer 70 with the inner wall of a countersink of the bore of the bit holder, which is beneficial during the initial insertion of the retainer 70 into the bore of the bit holder. During insertion, the direction of collapse 116 (FIG. 27) is radial, occurring initially adjacent the distal end 78 of the retainer 70. The addition of the reduced diameter distal section 84, the dual corner break 96, the relief notch 98, and the compression slot 102 allows for easier insertion of the distal end 78 of the retainer 70 into the bore of the bit holder.

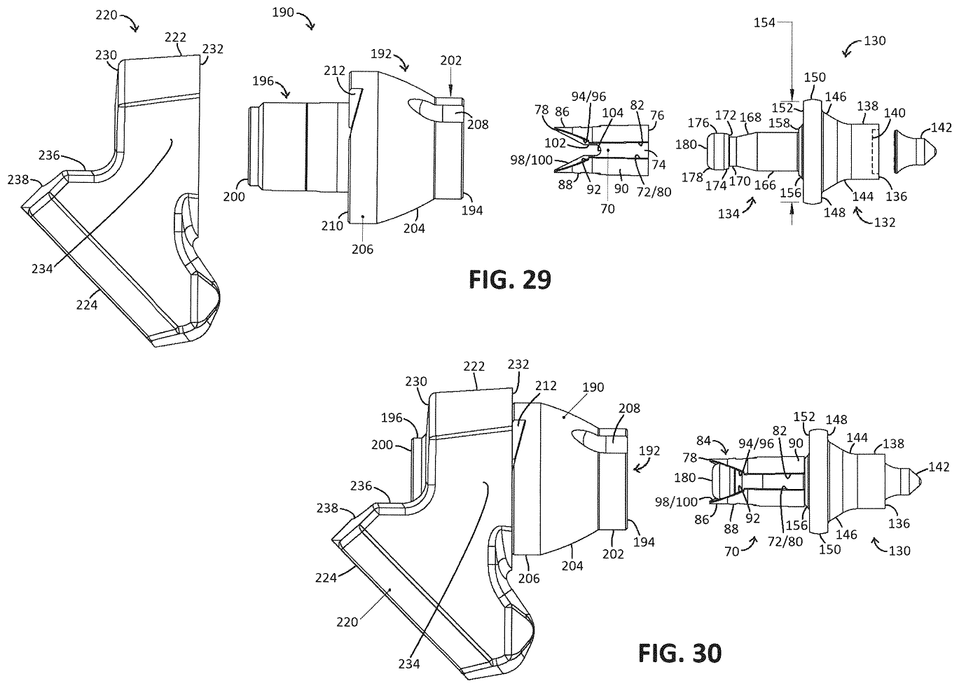

Referring to FIGS. 29-41, a first illustrated embodiment of a bit 130 comprises a bit body 132 and a bit shank 134 axially depending from a bottom of the bit body 132. The bit body 132 is generally cylindrical or generally annular in shape and comprises an annular or generally cylindrical top surface or forward end 136, such as a nearly flat annular top surface in the first illustrated embodiment, adjacent to an annular or generally cylindrical upper body portion 138 that includes an annular or generally cylindrical trough 140 (FIG. 29) in which to retain a brazed bit tip 142. An arcuate or concave first mediate body portion 144 adjacent the upper body portion 138 generally slopes axially and radially outwardly to an angular or conical second mediate body portion 146. In other embodiments, the first mediate body portion 144 and the second mediate body portion 146 can have a frustoconical shape, an arcuate shape, a convex shape, a concave shape, and/or any combination of same. The angular body portion 146 extends axially to a forward surface 148, which is planar in this exemplary illustrated implementation, of a radially extending generally arcuate enlarged washer feature or portion 150. The planar surface 148 of the washer feature 150 serves as a cut-material flow barrier that axially forces a rear annular flange 152 of the bit body 132 against a forward face of the bit holder with a greater force than a frustoconical profile on the forward end of the bit body. A unibody is formed in that the washer feature 150 is designed as part of the bit body 132. When the washer feature 150 is incorporated into the bit body 132 as a single component design, the cost of the unibody, i.e., the washer feature 150 and the bit body 132 combination, is about 20%-40% less cost than a two-part washer and cutter bit body configuration of a bit of the prior art.

The washer feature 150 comprises a distal outer diameter 154 that is, in this exemplary illustrated implementation, generally the same as a diameter of a nose portion of the bit holder, as shown in FIG. 37. In other embodiments, the diameter 154 of the washer feature 150 can be at least the diameter of the nose portion of the bit holder and/or greater than the diameter of the nose portion of the bit holder. The washer feature 150 of the bit body 132 is located in a forward position from the first flange 152, which denotes a bottom of the bit body 132. A decreased diameter tapered or angular distal portion 156 (FIGS. 29 and 38) extends from the first flange 152 of the washer feature 150 of the bit body 132 to a second flange 158 (FIGS. 29 and 38) at a distal end of the angular portion 156 adjacent a forward end 160 (FIG. 29) of the shank 134. In this exemplary illustrated implementation, the thickness or axial length of the washer feature 150, measured from the first flange 152 to the forward surface 148 of the washer feature 150, is generally from about ⅛ inch to ½ inch and is application specific. The first flange 152 and the second flange 158 may be flat, annular, generally cylindrical, and/or any other suitable shape and/or configuration. In this exemplary illustrated implementation, the first flange 152 includes a first transition radius or undercut 162 (FIG. 38) laterally adjacent a forward end of the tapered distal portion 156. The first transition radius 162 is a small radius that transitions from the rear annular flange 152 to the tapered distal portion 156. The second flange 158 also includes a second transition radius or undercut 164 (FIG. 38) laterally adjacent the forward end 160 of the bit shank 134. The second transition radius 164 is also a small radius that transitions from the second flange or shoulder 158 to the forward end 160 of the shank 134.

The bit shank 134 axially depends from the transition radius 164 of the second flange 158 adjacent a distal end of the decreased diameter tapered distal portion 156 and is axially aligned with the bit body 132. The shank 134 comprises a generally cylindrical first segment 166 that axially extends from the transition radius 164 of the second flange 158 to a tapered second segment 168. The second segment 168 axially extends from the first segment 166 to a generally cylindrical third segment 170. The third segment 170 axially extends from the second segment 168 to a third flange 172. An outwardly tapered fourth segment 174, adjacent the third flange 172, axially extends to a generally cylindrical fifth segment 176 comprising an arcuate portion 178 adjacent a distal end 180 of the bit shank 134. The shank 134 includes a notch 182 that extends axially inwardly from the distal end 180 of the bit shank 134. In other embodiments, the shank 134 can be generally cylindrical and/or can include cylindrical, tapered and/or arcuate segments. The distal hub or fifth segment 176 of the shank 134 may have a smaller diameter than the forward portion or first segment 166 of the shank 134, thereby reducing or eliminating the interference of cutting fines accumulating between an outer diameter of the of the distal end or fifth segment 166 of the shank 134 and an inner diameter of the retainer 70. The “V” shaped cutouts, such as the dual corner break 96 and the relief notch 98, designed into the distal end of the retainer further improves bit rotation when using the reduced diameter on the distal end 180 of the shank 134. The bit 130 comprises the enlarged tire portion 150 that includes a diameter that is generally the same as or larger than a diameter of the nose portion 202 of the bit holder 190 and, in this exemplary illustrated implementation, the shank 134 of the bit 130 comprises a forward diameter that is greater than or equal to a distal diameter of the distal hub or cap 176 of the shank 134 adjacent the distal end 180 of the shank 134 of the bit 130.

The shank 134 includes a coaxial and generally cylindrical collapsible slotted retainer, such as retainer 70 described herein, that is disposed circumferentially about the shank 134. The larger diameter forward end 76 of the retainer 70 provides greater radial pressure, thereby providing better retention of the bit during use. The retainer is generally made from spring steel or other hardenable material with an elasticity and a durability that allows the retainer to return to its nearly original shape despite significant deflection or twisting. The strength and compressibility of the retainer is determined by the material used for the retainer and the final hardness of the retainer after heat treating or other hardenable process as is known in the art.

Referring to FIGS. 29-41, a first illustrated embodiment of a bit holder 190 includes a bit holder body 192 adjacent a forward end 194 of the bit holder 190 and a bit holder shank 196 axially depending from the bottom of the bit holder body 192. The bit holder 190 comprises a central bore that axially extends from the forward end 194 of the bit holder body 192 to a distal end 200 of the bit holder 190/bit holder shank 196. The central bore 198 comprises a countersink 218 adjacent the top surface 194 of the bit holder body 192, such as a flat annular top surface, at the forward end of the bit holder body 192. The bit holder body 192 is generally annular in shape and comprises an annular or generally cylindrical upper body portion or nose portion 202 that axially extends from the top surface 194 to a middle body portion 204. The middle body portion 204 extends axially and radially outwardly to a radially extending generally cylindrical tire portion 206. A pair of notches 208 are formed into the bit holder body 192 and extend from the flat annular top surface 194. The notches 208 provide access and leverage for a tool to extract, or knock out, the bit 130 from the bit holder body 192. Generally, the bore of the bit holders accepts universal shank designs that are application specific.

Adjacent the tire portion 206 is a flange 210, such as a flat annular flange, that denotes the bottom of the bit holder body 192. The tire portion 206 includes a pair of tapered cutouts 212, or wedge-shaped undercuts, to provide access and leverage for a tool to extract the bit holder 190 from a base block. The tapered cutouts 212 are formed into the tire portion 206 and extend from the flange 210 adjacent to the tire portion 206. The tapered cutouts 212 include a pair of parallel flat vertical inner surfaces and a pair of flat tapered top surfaces. The outer edge of the flat tapered top surfaces of each tapered cutout 212 is each arcuate in shape to follow the periphery of the tire portion 206.

The bit holder shank 196 axially depends from the bottom of the bit holder body 192. The bit holder body 192 and the shank 196 are axially aligned with the bit holder bore 198. In this illustrated embodiment, the shank 196 includes a shortened 1½ inch length. In other embodiments, the shank 196 can include the standard 2⅝ inch length or other suitable length. The shank 196 also includes, in this illustrated embodiment, a slot 214 that extends from an upper termination 216 adjacent a forward end of the shank 196 to the distal end 200 of the shank 196. Optionally, or in an alternate embodiment, the shank 196 can also include an internally oriented second slot (not shown) that can be located approximately 180 degrees around the annular shank 196 from the slot 214. This second slot is parallel to the first slot 214 and is an internal slot having a rearward semicircular termination (not shown) inwardly adjacent to the distal end 200 of the shank 196 and a forward semicircular termination (not shown) generally coinciding longitudinally and axially with the upper termination 216 of the slot 214.

Referring to FIGS. 29-41, a first illustrated embodiment of the base block 220 comprises a shortened front end or bit holder receiving portion 222 and a base 224 adjacent the shortened front end 222. The base 224 can be flat or slightly concave to fit a drum or additional mounting plates on which a singular or a plurality of base blocks can be mounted. The shortened front end 222 includes a base block bore 226 (FIG. 37) that is symmetrical with the bit holder shank 196 along a centerline. The shortened front end 222 and the base block bore 226 extending axially through the shortened front end 222 are shortened to approximately 1.5 inches in length, in this exemplary illustrated implementation, by removing material from the rear of the shortened front end 222. The shortened front end 222 includes, in this embodiment, a slot 238 (FIG. 37) decreasing in radial size from a rear face 230 of the shortened front end 222 to a position mediate and/or adjacent a front face 232 of the shortened front end 222. The slot 238 provides added room for a punch (not shown) to operate and push the shank of a bit out of the bit holder. The shortened front end 222 also includes a pair of flat vertical sides 234 that extend near and/or adjacent to the base 224. The flat vertical sides 234 reduce the dimensions of the base block 220, including its width, and allow bit assemblies to be positioned in closer center-to-center axial bit tip orientation in order to degrade the road to a smoother surface.

The base block 220 also includes an arcuate bore extension 236 (FIG. 37) starting at an inner portion of the base block bore 226 adjacent the rear face 230 of the shortened front end 222 and extending toward a rear 238 of the base block 220. The extension 236 does not serve a function when the base block 220 is used with a shortened shank bit holder 190. However, over time the extreme forces from cutting conditions will wear the base block bore 226 and bit holder shank 196 such that the shortened shank bit holder 190 may not successfully be retained in the base block bore 226 and the shortened shank bit holder 190 must be replaced with a standard 2⅝ inch length shank bit holder (not shown). The extension 236 engages the 2⅝ inch long shank of the standard bit holder adjacent its distal end and provides sufficient radial support against that portion of the shank to retain the standard bit holder in the base block bore 226.

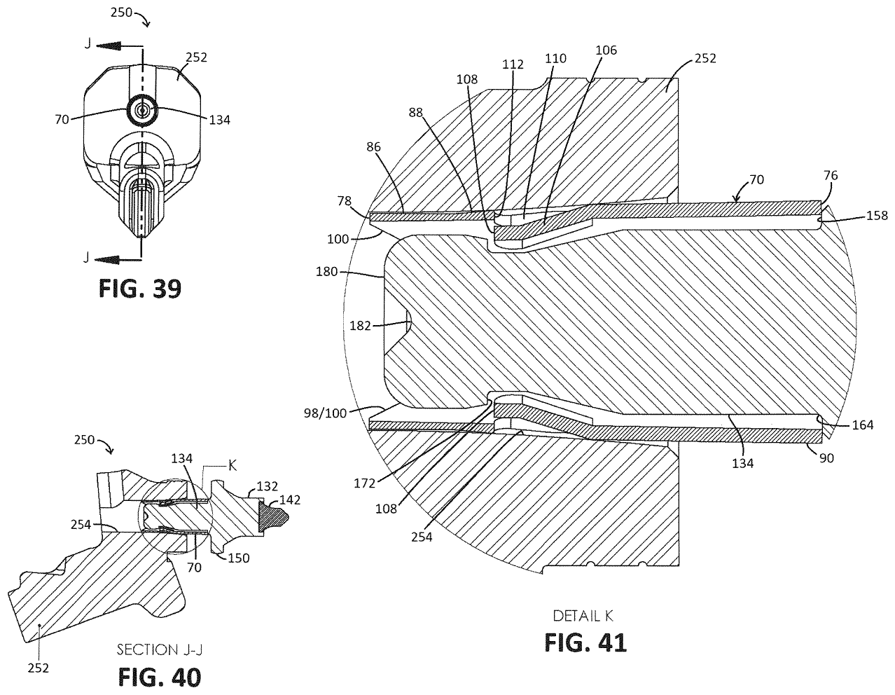

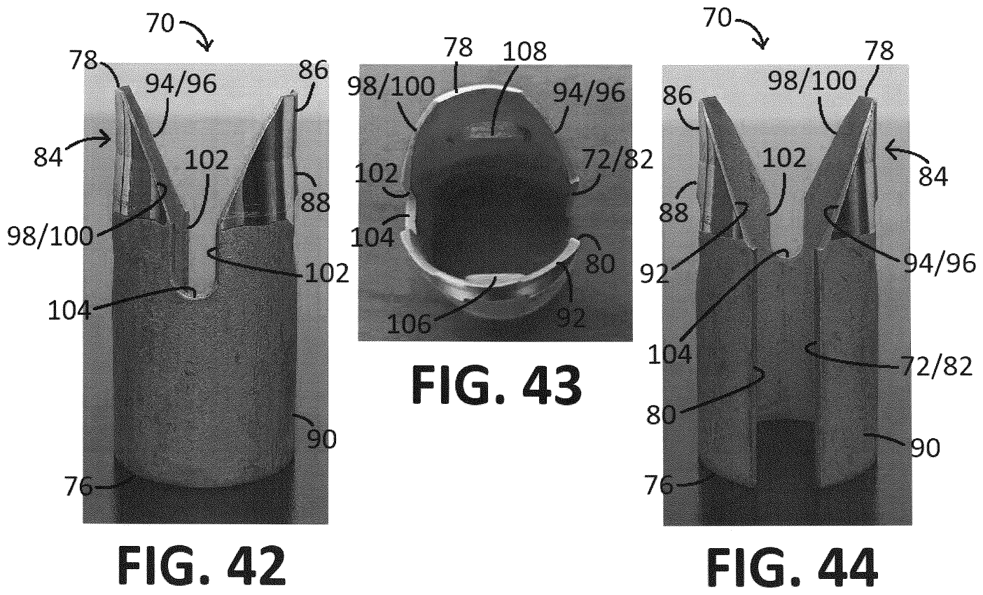

Referring to FIGS. 29 and 30, to mount the fully assembled bit 130 (FIG. 30), including the retainer 70 disposed circumferentially around the bit shank 134, into the bit holder 190 and base block 220 assembly (FIG. 30), the shank 134 of the bit 130 is aligned with the bore 198 of the bit holder 190. The radially collapsible slot 72, the dual corner break 96 extending from the slot 72 to the distal end 78 of the retainer 70, the reduced diameter distal section 84, the relief notch 98, and the radially collapsible compression slot 102 of retainer 70 provide for easier insertion of the bit shank 134/retainer 70 into the bore 198 of the bit holder 190. Bit 130 is shown assembled with retainer 70 during various stages of the bit insertion process into the bore 198 of the bit holder 190 of a first illustrated embodiment of a bit assembly 240 in FIGS. 29-38 and into a bore 254 of a prior art bit holder 252 of a second illustrated embodiment of a bit assembly 250 in FIGS. 39-41.

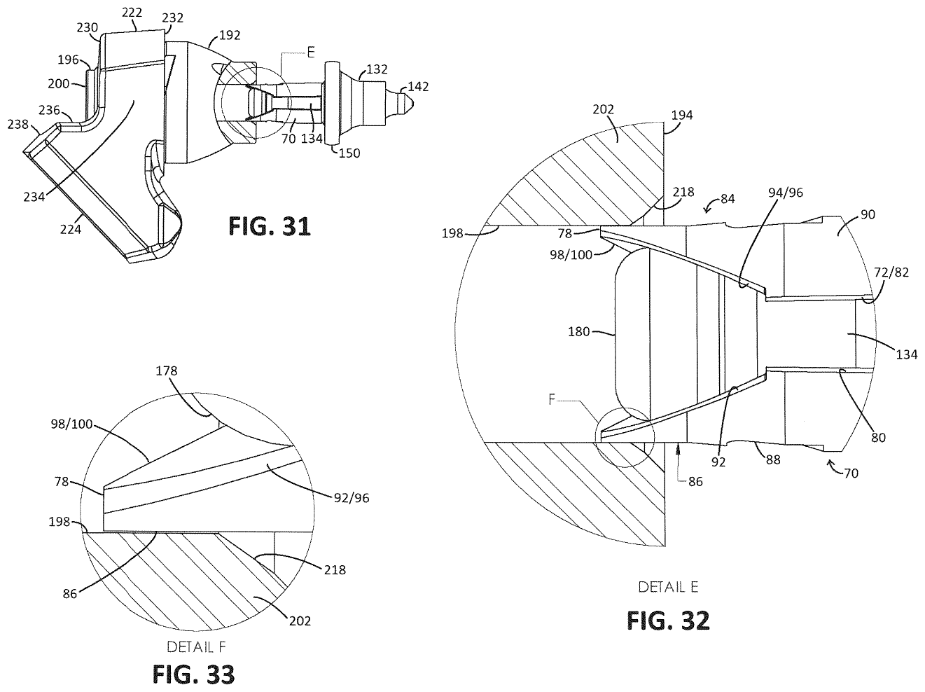

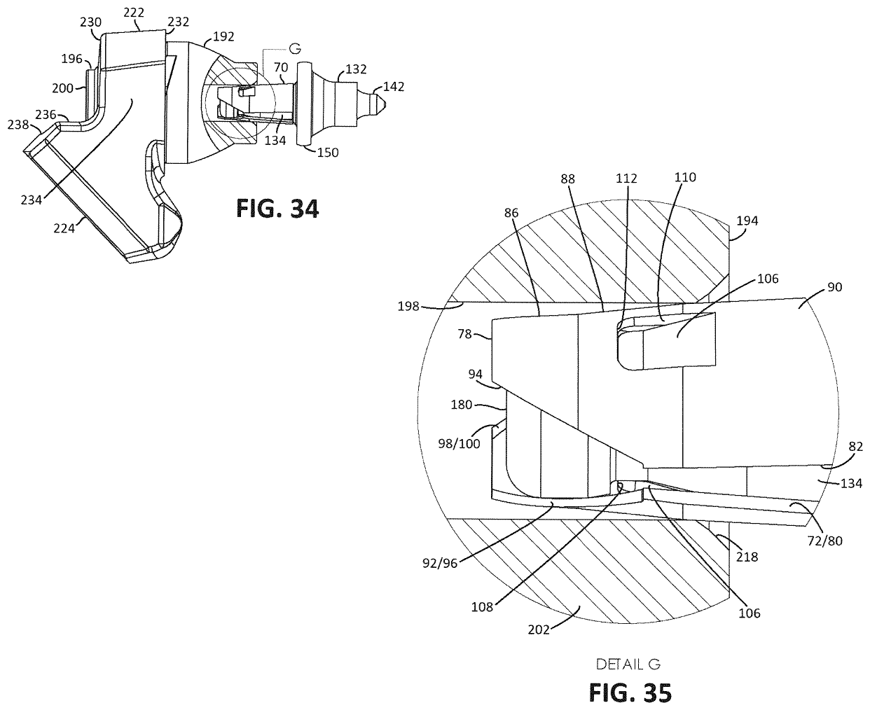

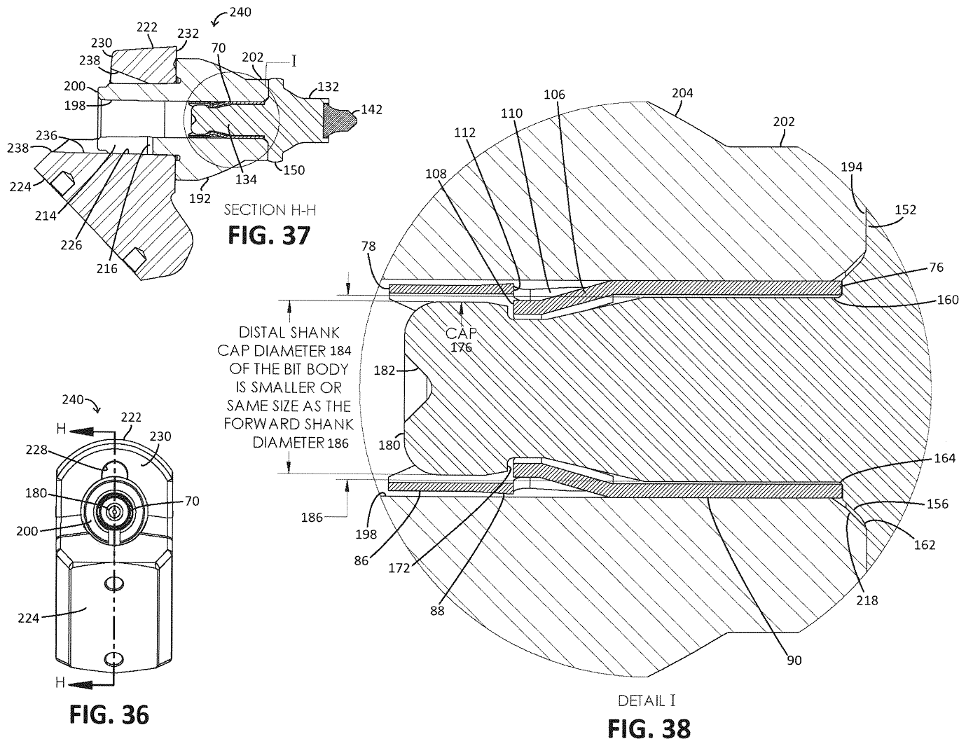

Referring to FIGS. 29-41, to insert the bit 130 into the bore 198 of the bit holder 190 (FIGS. 29-38) or the bore 254 of the prior art bit holder 252 (FIGS. 39-41), a user need only use manual force to manually insert the bit 130 into the bore 198, 254 of the bit holder 190, 252, respectively. Upon initial manual insertion of the bit 130 into the bore 198 of the bit holder 190, shown in FIGS. 31-33, or bore 254 of the prior art bit holder 252, the distal end 78 of retainer 70 may form a small and/or sufficient amount of radial interference with the bore 198 of the bit holder 190, as shown in FIG. 32, and the bore 254 of the prior art bit holder 252 at the generally cylindrical outer surface 86 of the reduced diameter distal section 84 of the retainer 70. After initial manual insertion of the bit 130 a short distance into the bore 198 of the bit holder 190 and the bore 254 of the prior art bit holder 252, the distal end 78 of the retainer 70 compresses to allow further manual insertion as needed to secure the bit 130 into the bore 198 of the bit holder 190, as shown in FIGS. 34 and 35, and the bore 254 of the prior art bit holder 252, as shown in FIG. 39-41. Upon seated and/or full insertion of the bit shank 134/retainer 70 into the bore 198 of the bit holder 190, shown in FIGS. 36-38, and the bore 254 of the prior art bit holder 252, the retainer 70 retains the bit 130 in the bore 198 of the bit holder 190 and the bore 252 of the prior art bit holder 252, when the bit holder 190, 252 is new, used, or at the end of its useful life, while still allowing uninhibited rotation of the bit 130 in the bore 198, 254 of the bit holder 190, 252, respectively. After the bit 130 is inserted into the bore 198 of the bit holder 190, the retainer 70 is axially fixed in place in a rearward seated position. The axial movement of the bit body 132 is then strictly controlled by the allowable clearance between the length of the bit shank 134 shoulders or flanges 158, 172 and the distal surfaces 108 of the tabs 106, respectively, to the distal end 78 of the retainer 70. The deviation between the shoulder dimensions 158, 172 and the distal surfaces 108 of the tabs 106 to the distal end 78 of the retainer 70 in the bit 130 in the exemplary illustrated implementations described herein is 0.01-0.075 inch.

When the bit 130 is fully inserted in the bore 198 of the bit holder 190, the tapered distal portion 156 of the bit 130 engages the countersink 218 of the bit holder 190 such that the complementary angles of the tapered distal portion 156 of the bit 130 and the countersink 218 of the bit holder 190 radially align the cutter bit 130 concentric with the bore 198 of the bit holder 190, as shown in FIG. 37. The reduced axial movement of the bit 130 allows the angled portion 156 to remain engaged with the countersink 218 that is adjacent the forward end 194 of the bit holder 190.

The angles of the tapered distal portion 156 of the bit 130 and the countersink 218 of the bit holder 190 form contacting angles after some use of the cutter bit 130. These contacting angle surfaces replicate the same wear pattern as a new bit and new bit holder configuration as the cutter bit is put to use. As the mutual wear pattern progresses, the angle of tapered distal portion 156 will develop a wear pattern that makes contact with the adjacent angled mating surface of countersink 218 and with the forward face 194 of the bit holder 190. This wear-in relationship between the tapered distal portion 156 and the countersink 218 can only occur when there is an integral bit body design that does not allow the washer to move separately to the bit body, i.e., the bit 130 comprising the integral washer feature of the present disclosure.

The reduced diameter of the reduced diameter distal section 84 at the distal end 78 of retainer 70 not only allows for easier insertion of the bit 130 into the bore 198, 254 of the bit holder 190, 252, respectively, but also does not restrict the amount of axial insertion of the bit/retainer assembly. By eliminating the washer to precompress the retainer, the improved design of retainer 70 not only reduces manufacturing costs, but also makes the retainer 70 more end-user friendly during the insertion of a bit into the bore of a bit holder, such as prior art bit holder 252 and the first illustrated embodiment of bit holder 190, that is new, used, or at the end of its useful life while still retaining the bit 130 within the worn-out bore 198 of the bit holder 190 by radial interference with the outer surface 90 of the retainer 70.

As used in this application, the term “or” is intended to mean an inclusive “or” rather than an exclusive “or”. That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. In addition, “X includes at least one of A and B” is intended to mean any of the natural inclusive permutations. That is, if X includes A; X includes B; or X includes both A and B, then “X includes at least one of A and B” is satisfied under any of the foregoing instances. The articles “a” and “an” as used in this application and the appended claims should generally be construed to mean “one or more” unless specified otherwise or clear from context to be directed to a singular form. Moreover, use of the term “an implementation” or “one implementation” throughout is not intended to mean the same embodiment, aspect or implementation unless described as such.

While the present disclosure has been described in connection with certain embodiments and measurements, it is to be understood that the invention is not to be limited to the disclosed embodiments and measurements but, on the contrary, is intended to cover various modifications and equivalent arrangements included within the scope of the appended claims, which scope is to be accorded the broadest interpretation so as to encompass all such modifications and equivalent structures as is permitted under the law.

What is claimed is:

1. A retainer comprising:
a tapered body portion comprising an axial forward end and an axial distal end;
a first slot extending through a sidewall of the tapered body portion from the axial forward end to adjacent the axial distal end; and
a reduced diameter distal section adjacent the axial distal end of the retainer, the reduced diameter distal section comprising a forward portion and a distal portion each comprising an outer diameter that is less than an outer diameter of the tapered body portion of the retainer forward of the reduced diameter distal section.

2. The retainer of claim 1, the tapered body portion comprising a taper greater than zero.

3. The retainer of claim 1, further comprising:
a forward outer surface of the forward portion tapered axially inwardly towards the axial distal end of the retainer.

4. The retainer of claim 1, further comprising one of:
a forward tapered outer surface of the distal portion tapered axially inwardly towards the axially distal end of the retainer; and
one of a distal tapered outer surface and a distal cylindrical outer surface of the distal portion.

5. The retainer of claim 1, the outer diameter of the tapered body portion at the axial forward end of the retainer being greater than the outer diameter of the tapered body portion adjacent the axial distal end of the retainer, the outer diameter of the tapered body portion at the axial forward end of the retainer adapted to provide greater radial pressure that provides better retention of a bit assembled into a bore of a bit holder.

6. A bit comprising:
a unitary body portion comprising a washer portion adjacent a distal end of the unitary body portion, the washer portion integrally formed as part of the unitary body portion; and
a generally cylindrical shank depending from a bottom of the body portion; and
a retainer disposed circumferentially about the shank, the retainer comprising:
a tapered body portion comprising an axial forward end and an axial distal end;
a first slot extending through a sidewall of the tapered body portion from the axial forward end to adjacent the axial distal end; and
a reduced diameter distal section adjacent the axial distal end of the retainer, the reduced diameter distal section comprising a forward portion and a distal portion each comprising an outer diameter that is less than an outer diameter of the tapered body portion of the retainer forward of the reduced diameter distal section.

7. The bit of claim 6, the tapered body portion of the retainer comprising a taper greater than zero.

8. The bit of claim 6, the retainer further comprising:
a forward outer surface of the forward portion tapered axially inwardly towards the axial distal end of the retainer.

9. The bit of claim 6, the retainer further comprising one of:
a forward tapered outer surface of the distal portion tapered axially inwardly towards the axially distal end of the retainer; and
one of a distal tapered outer surface and a distal cylindrical outer surface of the distal portion.

10. The bit of claim 6, the outer diameter of the tapered body portion at the axial forward end of the retainer being greater than the outer diameter of the tapered body portion adjacent the axial distal end of the retainer, the outer diameter of the tapered body portion at the axial forward end of the retainer adapted to provide greater radial pressure that provides better retention of the bit assembled into a bore of a bit holder.
